(19) United States
(12) Patent Application Publication
(10) Pub. No.: US 2026/0218752 A1
(43) Pub. Date: Jul. 30, 2026

(54) BEARING SEAL

(71) Applicant: NAKANISHI METAL WORKS CO., LTD., Osaka-shi, Osaka (JP)

(72) Inventor: Taro YUKIOKA, Osaka-shi (JP)

(73) Assignee: NAKANISHI METAL WORKS CO., LTD., Osaka-shi, Osaka (JP)

(21) Appl. No.: 19/141,795

(22) PCT Filed: Dec. 6, 2023
(86) PCT No.: PCT/JP2023/043670

§ 371 Date: Jun. 20, 2025

(30) Foreign Application Priority Data
Feb. 17, 2023 (JP) 2023-023771

(51) Int. Cl. F16C 33/78

(52) U.S. Cl. CPC F16C 33/7816; F16C 2202/32; F16C 2380/26

(57) ABSTRACT

A bearing seal includes an annularly-shaped seal ring having a core metal 4 and an elastic body, and a conductive material in contact with an outer ring and an inner ring to electrically connect the outer and inner rings. The conductive material is a conductive fibrous body that is a bundle of conductive fibers, and is retained by the seal ring while joined to the elastic body. A radially outer end of the conductive fibrous body protrudes radially outward from the seal ring, and comes in contact with the outer ring at a position that is outward in a width direction in a rolling bearing relative to the core metal 4. A radially inner end of the conductive fibrous body protrudes radially inward from the seal ring and comes in contact with the inner ring at a position that is outward in the width direction in the rolling bearing relative to the core metal 4.

### TECHNICAL FIELD

The present invention relates to a bearing seal for preventing electrolytic corrosion of a rolling bearing.

### BACKGROUND ART

In a motor and a speed reducer unit in an electric vehicle and an inverter-driven motor incorporated in equipment other than an electric vehicle, for example, current may leak and flow through a rotating shaft. In such a case, in a rolling bearing supporting the rotating shaft, a current may penetrate a lubricating oil film and flow between an inner ring and an outer ring, causing an arc that damages a rolling surface of a rolling element.

As a bearing seal that prevents such electrolytic corrosion of the rolling bearing, a bearing seal having a conduction mechanism for electrically connecting an inner ring and an outer ring is known (see, for example, Patent Literature 1 (PTL 1)). A conduction mechanism 19 shown in FIGS. 1-2 of PTL 1 is configured such that conductive materials 18 having flexibility and conductivity are buried and retained in an elastic body 12 that forms a seal ring 10a.

A protrusion 13, which is an outer-diameter-side lip of the seal ring 10a, is engaged in an engagement groove 9 of an outer ring 3, and a radially outer end of each conductive material 18 is exposed from a radially outer edge of the protrusion 13 and comes in direct contact with an inner surface of the engagement groove 9. A seal lip 14, which is an inner-diameter-side lip of the seal ring 10a, slides in a seal groove 15 of an inner ring 5, and a radially inner end of each conductive material 18 is exposed from a radially inner edge of the seal lip 14 and comes in direct contact with an inner surface of the seal groove 15.

### CITATIONS LIST

### Patent Literature

PTL 1: Japanese Unexamined Patent Application Publication No. 2009-79643

### SUMMARY OF INVENTION

### Technical Problems

For the bearing seal described in PTL 1, it is extremely difficult to manufacture a bearing seal that has the configuration in which the conductive materials 18 are buried and retained in the elastic body 12 forming the seal ring 10a, and each conductive material 18 is exposed from the radially outer edge of the outer-diameter-side lip as each conductive material 18 is exposed from the radially inner edge of the inner-diameter-side lip, causing the conductive material 18 to be in certainly contact with the outer ring 3 and with the inner ring 5.

When the inner-diameter-side seal lip 14 is a contact type, as shown in FIG. 1 of PTL 1, only the conductive material 18 may be in contact with the seal groove 15 of the inner ring 5, which raises a concern that the inner-diameter-side seal lip 14 cannot exert a function of a contact type seal.

An object of the present invention is to provide a bearing seal that prevents electrolytic corrosion of a rolling bearing, reduces conductive resistance, improves conductive stability, and facilitates manufacturing of the bearing seal. Another object of the present invention is to ensure that sealing performance is not affected at all even in a seal type in which a lip is in slidably contact with an inner ring.

### Solutions to Problems

A bearing seal according to a first aspect of the present invention is a bearing seal used for a rolling bearing including an outer ring, an inner ring, and rolling elements. The bearing seal includes: an annularly-shaped seal ring including a core metal and an elastic body; and a conductive material in contact with the outer ring and the inner ring to electrically connect the outer ring and the inner ring. The elastic body has an outer-diameter-side lip extending radially outward and an inner-diameter-side lip extending radially inward. The outer-diameter-side lip is engaged in an engagement groove of the outer ring. The inner-diameter-side lip is a non-contact lip that is not in contact with the inner race or a contact lip that is in contact with the inner ring. The conductive material is a conductive fibrous body that is a bundle of conductive fibers and is retained by the seal ring in a state where the conductive fibrous body is buried in the elastic body or is joined to the elastic body. A radially outer end of the conductive fibrous body protrudes radially outward from the seal ring, and comes in contact with the outer ring at a position that is outward in a width direction in the rolling bearing relative to the core metal. A radially inner end of the conductive fibrous body protrudes radially inward from the seal ring, and comes in contact with the inner ring at a position that is outward in the width direction in the rolling bearing relative to the core metal.

A bearing seal according to a second aspect of the present invention is a bearing seal used for a rolling bearing including an outer ring, an inner ring, and rolling elements. The bearing seal includes: an annularly-shaped seal ring including a core metal and an elastic body; and a conductive material that is in contact with the outer ring and the inner ring to electrically connect the outer ring and the inner ring. The elastic body has an inner-diameter-side lip extending radially inward and an outer-diameter-side lip extending radially outward. The inner-diameter-side lip is engaged in an engagement groove of the inner ring. The outer-diameter-side lip is a non-contact lip that is not in contact with the outer ring or is a contact lip that is in contact with the outer ring. The conductive material is a conductive fibrous body that is a bundle of conductive fibers and is retained by the seal ring in a state where the conductive fibrous body is buried in the elastic body or is joined to the elastic body. A radially inner end of the conductive fibrous body protrudes radially inward from the seal ring, and comes in contact with the inner ring at a position that is outward in a width direction in the rolling bearing relative to the core metal. A radially outer end of the conductive fibrous body protrudes radially outward from the seal ring, and comes in contact with the outer ring at a position that is outward in the width direction in the rolling bearing relative to the core metal.

In the configurations of the bearing seals according to the first and second aspects, the conductive material in contact with the outer ring and the inner ring of the rolling bearing to electrically connect the outer ring and the inner ring is the conductive fibrous body that is a bundle of conductive fibers and is retained by the seal ring in a state where the conductive fibrous body is buried in the elastic body of the seal ring or is joined to the elastic body of the seal ring. The radially outer end of the conductive fibrous body protrudes radially outward from the seal ring, and comes in contact with the outer ring at a position that is outward in the width direction in the rolling bearing relative to the core metal. The radially inner end of the conductive fibrous body protrudes radially inward from the seal ring, and comes in contact with the inner ring at a position that is outward in the width direction in the rolling bearing relative to the core metal.

In other words, not the elastic body but the conductive fibrous body independent of the elastic body comes in contact with the outer ring and the inner ring. The radially inner end of the conductive fibrous body slides over the inner ring, or the radially outer end of the conductive fibrous body slides over the outer ring. In this manner, the conductive fibrous body, which is a bundle of conductive fibers, is in direct contact with the outer ring and the inner ring of the rolling bearing to electrically connect the outer ring and the inner ring, thereby reducing conductive resistance and achieving excellent conductive stability in comparison with a conductive rubber constructed by mixing a filler (conductive material) into a rubber.

In addition, in comparison with the bearing seal of PTL 1 in which the conductive material in the outer-diameter-side lip of the elastic body of the seal ring comes in contact with the outer ring and the conductive material in the inner-diameter-side lip of the elastic body of the seal ring comes in contact with the inner ring, the conductive fibrous body, i.e., the conductive material is allowed to come in contact certainly with the outer ring and the inner ring. This significantly improves conductive stability and facilitates manufacturing of the bearing seal. Furthermore, even if the bearing seal is a type of seal whose lip is in slidably contact with the inner ring, its conductive material is not exposed from the lip and is independent of the lip. Therefore, the conductive material does not affect sealing performance.

A bearing seal according to a third aspect of the present invention is a bearing seal used for a rolling bearing including an outer ring, an inner ring, and rolling elements. The bearing seal includes: an annularly-shaped metal seal plate; and a conductive material joined to the seal plate. A radially outer end of the seal plate is engaged in an engagement groove of the outer ring. The conductive material is a conductive fibrous body that is a bundle of conductive fibers. A radially inner end of the conductive fibrous body protrudes radially inward from the seal plate, and comes in contact with the inner ring at a position that is outward in a width direction of the rolling bearing relative to the seal plate.

A bearing seal according to a fourth aspect of the present invention is a bearing seal used for a rolling bearing including an outer ring, an inner ring, and rolling elements. The bearing seal includes: an annularly-shaped metal seal plate; and a conductive material joined to the seal plate. A radially inner end of the seal plate is engaged in an engagement groove of the inner ring. The conductive material is a conductive fibrous body that is a bundle of conductive fibers. A radially outer end of the conductive fibrous body protrudes radially outward from the seal plate, and comes in contact with the outer ring at a position that is outward in the width direction of the rolling bearing relative to the seal plate.

According to the configurations of the bearing seals according to the third and fourth aspects, the radially outer end of the an annularly-shaped seal plate is engaged in the engagement groove of the outer ring, and the radially inner end of the conductive fibrous body, which is a bundle of conductive fibers and is joined to the seal plate, comes in contact with the inner ring at a position that is outward in the width direction in the rolling bearing relative to the seal plate. Alternatively, the radially inner end of the annularly-shaped metal seal plate is engaged in the engagement groove of the inner ring, and the radially outer end of the conductive fibrous body, which is a bundle of conductive fibers and is joined to the seal plate, comes in contact with the outer ring at a position that is outward in the width direction in the rolling bearing relative to the seal plate.

In other words, not the elastic body but the conductive fibrous body and the metal seal plate come in contact with the outer ring and the inner ring. The radially inner end of the conductive fibrous body slides over the inner ring, or the radially outer end of the conductive fibrous body slides over the outer ring. It is easy to allow the conductive fibrous body to come in contact with both the inner ring and the outer ring. In such a case, the conductive fibrous body, which is a bundle of conductive fibers, is in direct contact with the outer ring and the inner ring of the rolling bearing to electrically connect the outer ring and the inner ring, thereby reducing conductive resistance and enhancing conductive stability, in comparison with a conductive rubber obtained by mixing a filler (conductive material) into a rubber. Even if the metal seal plate comes in contact with one of the outer ring and the inner ring of the rolling bearing without allowing the conductive fibrous body to come in contact therewith, conductive resistance is reduced and conductive stability is improved, in comparison with the conductive rubber.

In addition, in comparison with the bearing seal of PTL 1 in which the conductive material in the outer-diameter-side lip of the elastic body of the seal ring comes in contact with the outer ring and the conductive material in the inner-diameter-side lip of the elastic body of the seal ring comes in contact with the inner ring, conductive stability is improved significantly and manufacturing of the bearing seal is facilitated.

A bearing seal according to a fifth aspect of the present invention is one of the bearing seals according to the first aspect to the fourth aspect, in which the conductive fibrous body extends linearly in a radial direction.

According to the configuration of the bearing seal according to the fifth aspect, the conductive fibrous body, which is a bundle of conductive fibers, extends linearly in the radial direction, thereby allowing the conductive fibers forming the conductive fibrous body to be easily bundled together and facilitating to manufacture the conductive fibrous body.

### Advantageous Effects of Invention

As described above, according to the bearing seal of the present invention that prevents electrolytic corrosion of the rolling bearing, the conductive fibrous body, which is a bundle of conductive fibers, is in direct contact with the outer ring and the inner ring of the rolling bearing to electrically connect the outer ring and the inner ring, or the metal seal plate comes in contact with one of the outer ring and the inner ring of the rolling bearing without allowing the conductive fibrous body to come in contact therewith. This configuration reduces conductive resistance and improves conductive stability, and facilitates manufacturing of the bearing seal. Furthermore, even if the bearing seal is a type of seal whose lip is in slidably contact with the inner ring, its conductive material is not exposed from the lip and is independent of the lip, and therefore the conductive material does not affect sealing performance.

### BRIEF DESCRIPTION OF DRAWINGS

FIG. 1 is a perspective view of a section of a part of a rolling bearing according to an embodiment of the present invention, showing an example in which conductive materials are retained by a seal ring while buried in an elastic body, and an inner-diameter-side lip of the elastic body is a non-contact lip.

FIG. 2 is an enlarged longitudinal sectional view of a main part of the rolling bearing of FIG. 1.

FIG. 3 is a top view of the rolling bearing of FIG. 1 seen in the direction of its rotation center axis.

FIG. 4 is a perspective view of a section of a part of the rolling bearing according to the embodiment of the present invention, showing an example in which the conductive materials are retained by the seal ring while jointed to the elastic body, and the inner-diameter-side lip of the elastic body is the non-contact lip.

FIG. 5 is an enlarged longitudinal sectional view of a main part of the rolling bearing of FIG. 4.

FIG. 6 is a top view of the rolling bearing of FIG. 4 seen in the direction of its rotation center axis.

FIG. 7 is a perspective view of a section of a part of the rolling bearing according to the embodiment of the present invention, showing an example in which the conductive materials are retained by the seal ring while joined to the elastic body, and the inner-diameter-side lip of the elastic body is a contact lip.

FIG. 8 is an enlarged longitudinal sectional view of a main part of the rolling bearing of FIG. 7.

FIG. 9 is a top view of the rolling bearing of FIG. 7 seen in the direction of its rotation center axis.

FIG. 10 is an enlarged longitudinal sectional view of a main part in an example in which the conductive material of the bearing seal of FIGS. 7 to 9 is buried in the elastic body in the same manner as the conductive material of the bearing seal of FIGS. 1 to 3 is.

FIG. 11 is an enlarged longitudinal sectional view of a main part, showing an example in which an inner ring has no seal groove in the rolling bearing of FIGS. 1 to 3.

FIG. 12 is an enlarged longitudinal sectional view of a main part, showing an example of the bearing seal that includes an annularly-shaped metal seal plate and the conductive material.

### DESCRIPTION OF EMBODIMENTS

Hereinafter, embodiments according to the present invention will be described with reference to the drawings.

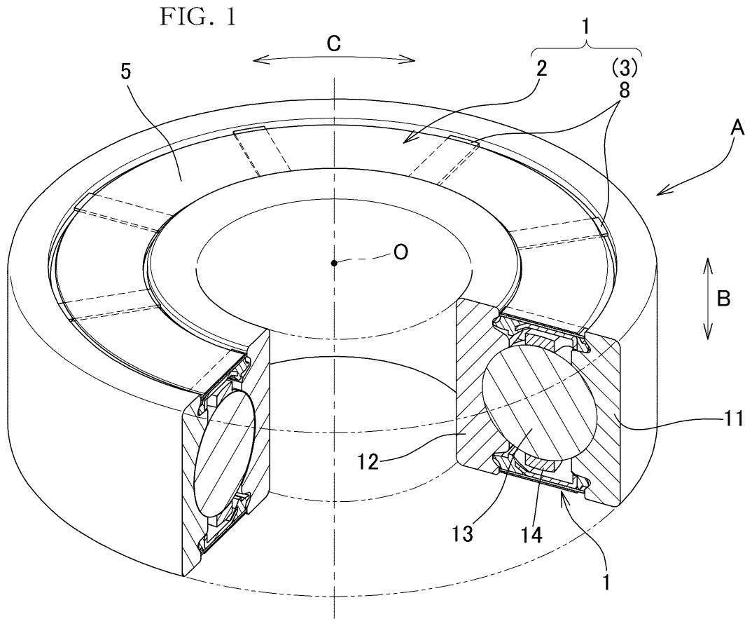

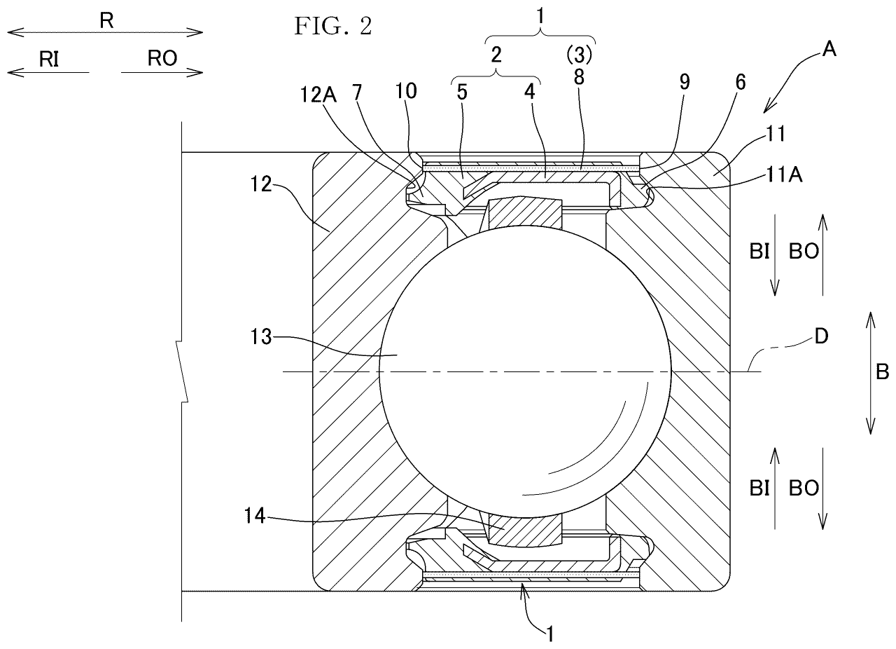

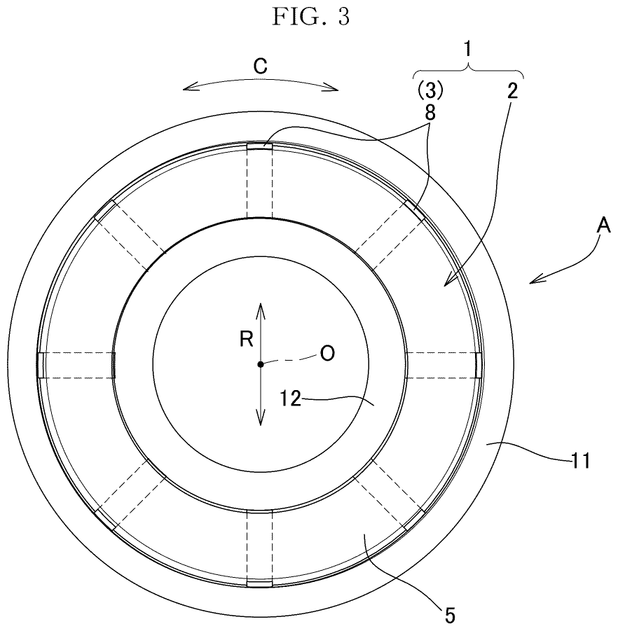

In the present specification, a direction parallel to the direction of a rotation center axis of a rolling bearing (see, for example, reference sign O in FIGS. 1 and 3) is referred to as a “width direction” (see, for example, arrow B in FIGS. 1 and 2), and a direction perpendicular to the direction of the rotation center axis is referred to as a “radial direction” (see, for example, arrow R in FIGS. 2 and 3). With respect to the direction of the rotation center axis, a “circumferential direction” (see, for example, arrow C in FIGS. 1 and 3) is defined.

In the present specification, a width direction approaching the center of the rolling bearing (see, for example, reference sign D in FIG. 2) in the width direction is referred to as “inward in the width direction” (see, for example, arrow BI in FIG. 2), a width direction away from the center in the width direction is referred to as “outward in the width direction” (see, for example, arrow BO in FIG. 2), a radial direction approaching the rotation center axis is referred to as “inward in the radial direction” (see, for example, arrow RI in FIG. 2), and a radial direction away from the rotation center axis is referred to as “outward in the radial direction” (see, for example, arrow RO in FIG. 2).

### Rolling Bearing

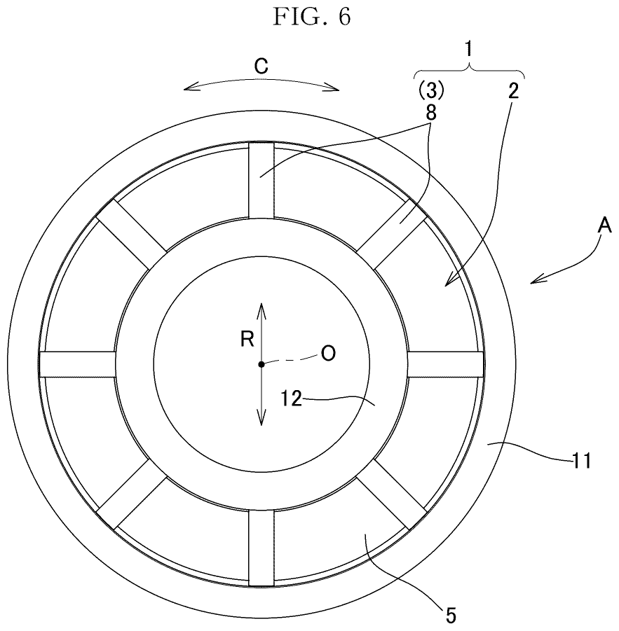

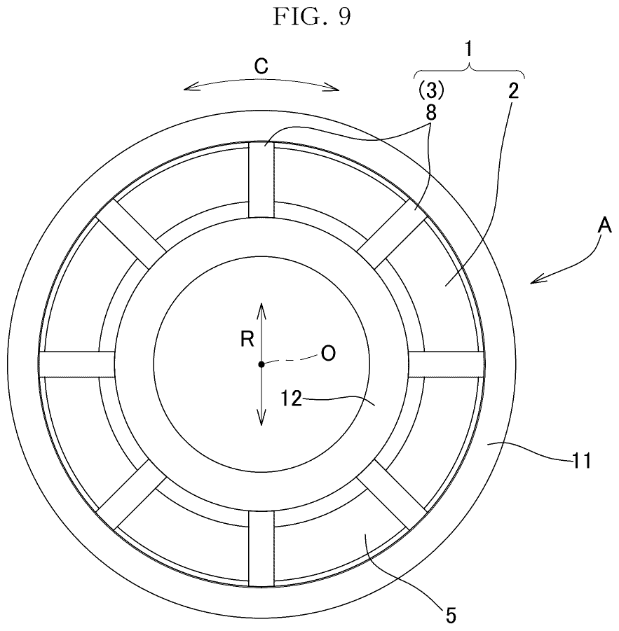

A rolling bearing A shown in FIGS. 1 to 12 includes an outer ring 11, an inner ring 12, rolling elements 13, a retainer 14, and a bearing seal 1. The rolling elements 13 roll between a raceway surface of the outer ring 11 and a raceway surface of the inner ring 12. The retainer 14 guides the rolling elements 13 at predetermined intervals and retains the rolling elements 13 in a manner that the rolling elements 13 are freely rotatable.

### Bearing Seal

The bearing seal 1 shown in FIGS. 1 to 11 includes an annularly-shaped seal ring 2, and conductive materials 3 that are in contact with the outer ring 11 and the inner ring 12 to electrically connect the outer ring 11 and the inner ring 12.

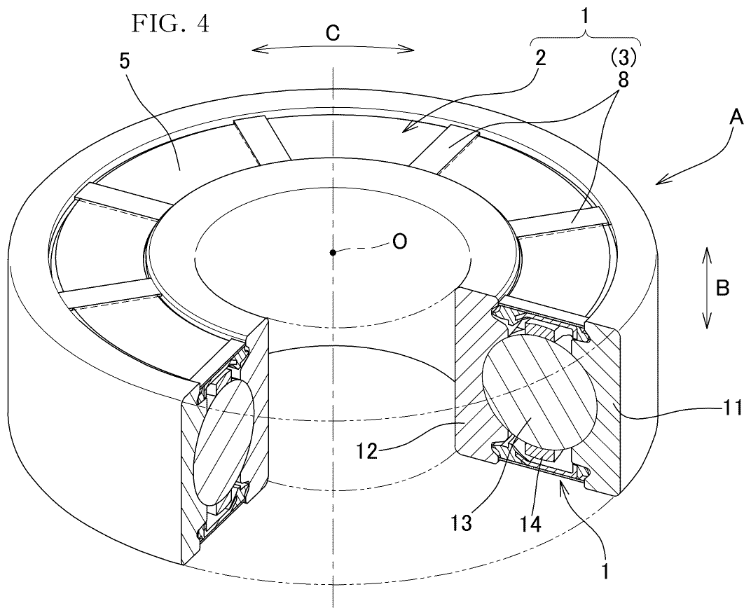

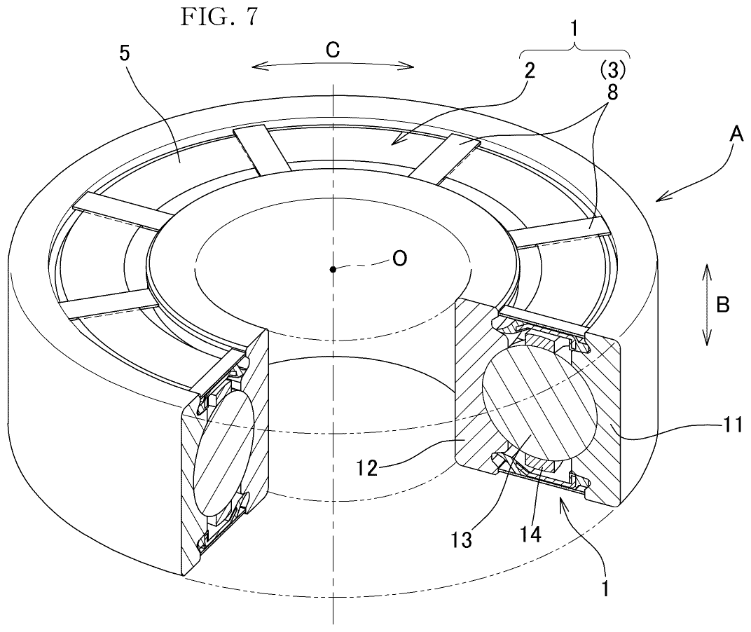

FIGS. 1 to 3 show an example of the bearing seal 1 in which each conductive material 3 is retained by the seal ring 2 while buried in an elastic body 5, and an inner-diameter-side lip 7 of the elastic body 5 is a non-contact lip. FIGS. 4 to 6 show an example of the bearing seal 1 in which the conductive material 3 is retained by the seal ring 2 while joined to the elastic body 5, and the inner-diameter-side lip 7 of the elastic body 5 is a non-contact lip. FIGS. 7 to 9 show an example of the bearing seal 1 in which the conductive material 3 is retained by the seal ring 2 while joined to the elastic body 5, and the inner-diameter-side lip 7 of the elastic body 5 is a contact lip.

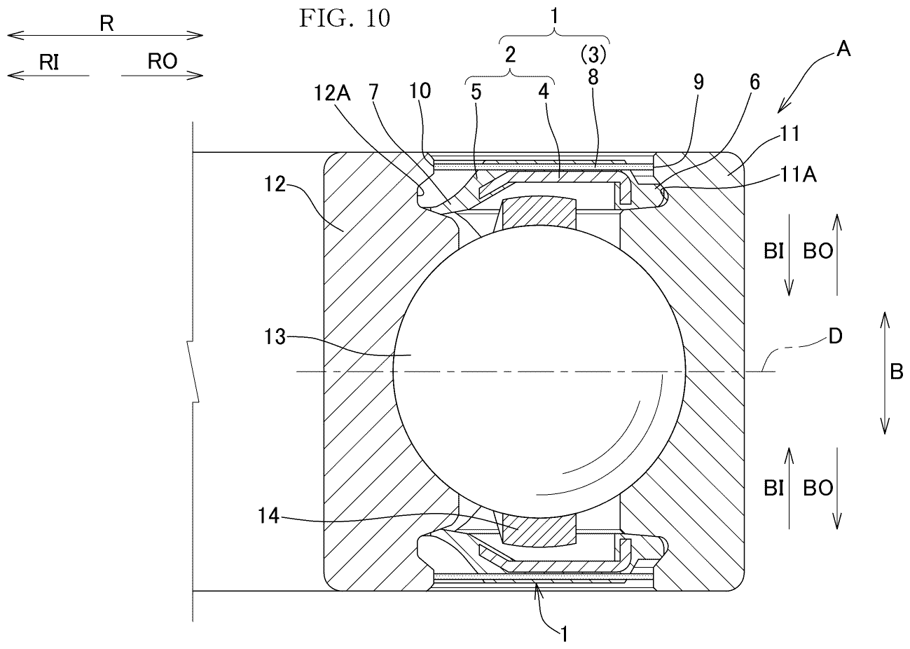

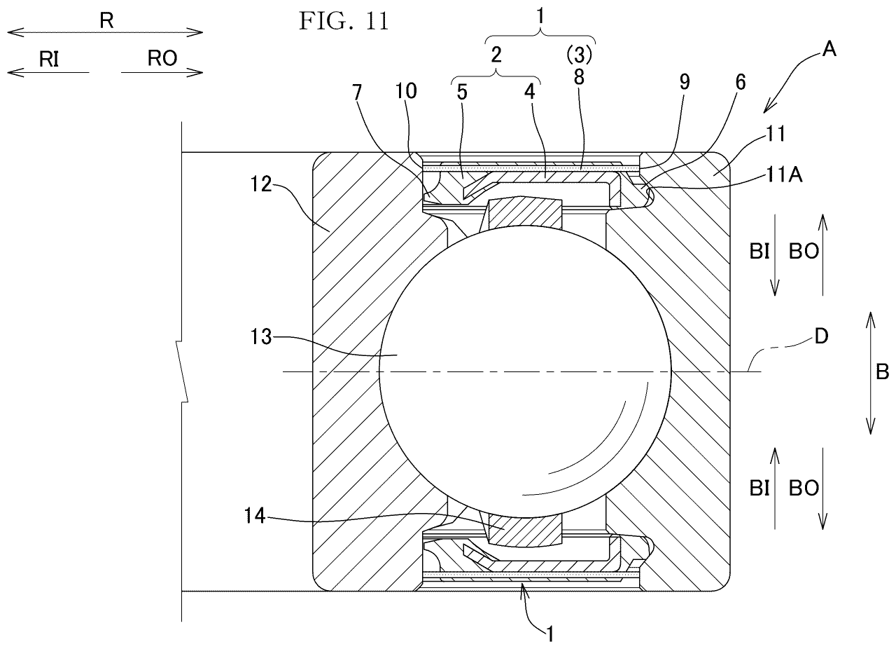

FIG. 10 shows an example of the bearing seal 1 in which the conductive material 3 of the bearing seal 1 in FIGS. 7 to 9 is buried in the elastic body 5 in the same manner as the conductive material 3 shown in FIGS. 1 to 3. FIG. 11 shows an example of the bearing seal 1 in which the inner ring 12 has no seal groove in the rolling bearing A in FIGS. 1 to 3.

The seal ring 2 shown in FIGS. 1 to 11 is composed of a core metal 4 and the elastic body 5. The core metal 4 is made of a metal material, and the elastic body 5 is made of a rubber material. The elastic body 5 has an outer-diameter-side lip 6 extending outward RO in the radial direction R, and the inner-diameter-side lip 7 extending inward RI in the radial direction R.

In the bearing seal 1 shown in FIGS. 1 to 11, the outer-diameter-side lip 6 is engaged in an engagement groove 11A of the outer ring 11, as shown in FIGS. 2, 5, 8, 10, and 11.

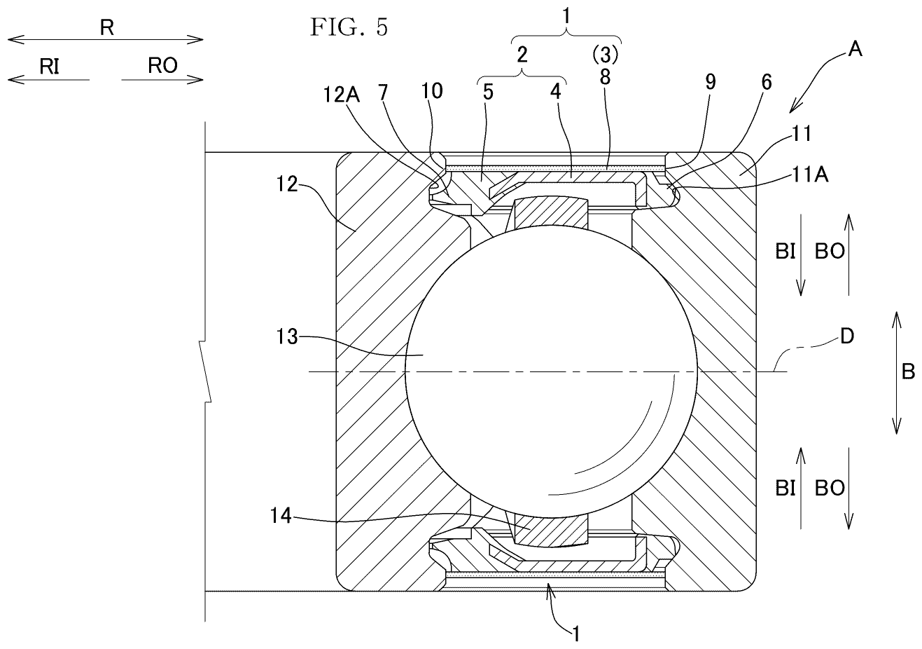

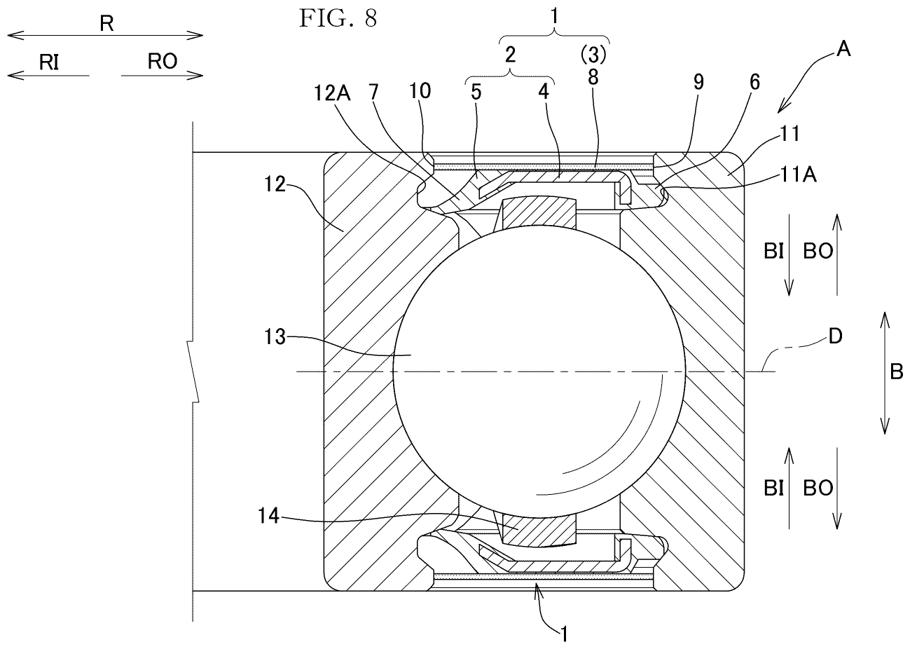

In the bearing seal 1 shown in FIGS. 1 to 6, the inner-diameter-side lip 7 is a non-contact lip located in a seal groove 12A of the inner ring 12, as shown in FIGS. 2 and 5. In the bearing seal 1 shown in FIGS. 7 to 10, the-inner-diameter-side lip 7 is a contact lip in contact with an inner surface of the seal groove 12A of the inner ring 12, as shown in FIGS. 8 and 10. In the bearing seal 1 shown in FIG. 11, the inner-diameter-side lip 7 is a non-contact lip that faces an outer peripheral surface of the inner ring 12 having no seal groove 12A. The inner-diameter-side lip 7, which is the non-contact lip or the contact lip, is located inward BI relative to the conductive material 3 in the width direction B, and is independent of the conductive material 3.

The inner-diameter-side lip 7 is provided as the non-contact lip, thereby reducing a sliding torque. The inner-diameter-side lip 7 is provided as the contact lip, resulting in an increase in the sliding torque but also enhancing sealing performance.

In the bearing seal 1 shown in FIGS. 1 to 3 and in FIGS. 10 and 11, the conductive material 3 is retained by the seal ring 2 while buried in the elastic body 5. In the bearing seal 1 shown in FIGS. 4 to 9, the conductive material 3 is retained by the seal ring 2 while joined to an outer surface of elastic body 5, which is located outward BO in the width direction B.

The conductive material 3 is a conductive fibrous body 8 that is a bundle of conductive fibers. For the conductive fibers, carbon fibers, chemical fibers coated with metal, or the like are used. For the metal coat of the chemical fibers, copper, silver, and/or nickel may be used. The carbon fibers may be reinforced by adding a polyester resin, a polyvinyl chloride resin, or the like to the carbon fibers.

In the bearing seal 1 of FIGS. 1 to 11, an outer end 9 of the conductive fibrous body 8 in the radial direction R protrudes outward RO in the radial direction R from the seal ring 2 and comes in contact with the outer ring 11 at a position that is outward BO in the width direction B of the rolling bearing A relative to the engagement groove 11A of the outer ring 11, as shown in FIGS. 2, 5, 8, 10, and 11. An inner end 10 of the conductive fibrous body 8 in the radial direction R protrudes inward RI in the radial direction R from the seal ring 2 and comes in contact with the inner ring 12 at a position that is outward BO in the width direction B of the rolling bearing A relative to the core metal 4.

As shown in FIGS. 3, 6, and 9, the conductive fibrous bodies 8 extend in the radial direction R and are retained by the seal ring 2 while arranged at substantially equal intervals in the circumferential direction C. As shown in FIGS. 1 to 11, each of the conductive fibrous bodies 8, which is a bundle of conductive fibers, extends linearly in the radial direction R. Accordingly, the conductive fibers forming the conductive fibrous body 8 are easily bundled together, and therefore manufacturing the conductive fibrous body 8 becomes easy.

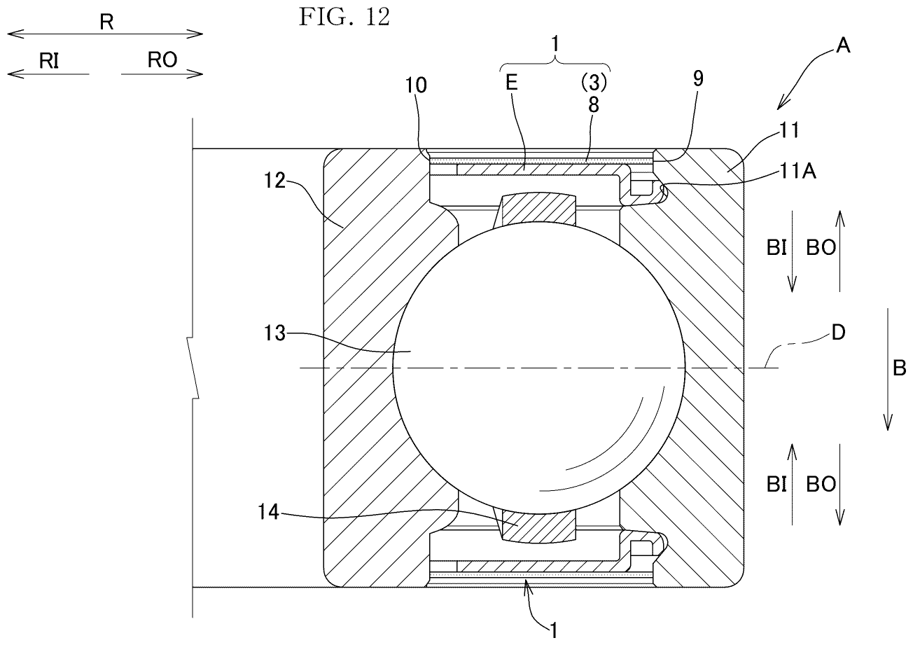

The bearing seal 1 shown in FIG. 12 includes an annularly-shaped metal seal plate E, and the conductive material 3 that is in contact with the outer ring 11 and the inner ring 12 to electrically connect the outer ring 11 and the inner ring 12. The conductive material 3 is joined to an outer surface of seal plate E that is located outward BO in the width direction B. An outer end of seal plate E that is located outward RO in the radial direction R is engaged in the engagement groove 11A of the outer ring 11. The inner end 10 of the conductive fibrous body 8 in the radial direction R protrudes inward RI in the radial direction R from an annular part of the seal plate E, and comes in contact with the inner ring 12 at a position that is outward BO of the rolling bearing A in the width direction B relative to the seal plate E. The outer end 9 of the conductive fibrous body 8 in the radial direction R protrudes outward RO in the radial direction R from the annular part of the seal plate E, and comes in contact with the outer ring 11 at a position that is outward BO of the rolling bearing A in the width direction B relative to the seal plate E. The outer end of seal plate E that is located outward RO in the radial direction R is engaged in the engagement groove 11A of the outer ring 11, thereby allowing the seal plate E and the outer ring 11 to be electrically connected. Thus, the outer end 9 of the conductive fibrous body 8 in the radial direction R may not be in contact with the outer ring 11.

In the embodiment shown in FIGS. 1 to 12, eight conductive fibrous bodies 8 are arranged at substantially equal intervals in the circumferential direction C, as shown in FIGS. 3, 6, and 9, for example. The present invention is, however, not limited to such a configuration. Specifically, the number of conductive fibrous bodies 8 is not limited to a specific number, and the conductive fibrous bodies 8 in contact with the outer ring 11 and/or the inner ring 12 on a certain part of the circumference are considered to be applicable. For example, the conductive fibrous bodies 8 may be connected together along the entire circumference.

In the bearing seal 1 shown in FIGS. 1 to 11, the outer-diameter-side lip 6 of the elastic body 5 is engaged in the engagement groove 11A of the outer ring 11. In the bearing seal 1 shown in FIG. 12, the outer end of seal plate E that is located outward RO in the radial direction R is engaged in the engagement groove 11A of the outer ring 11. These bearing seals are, therefore, a sliding-over-inner-ring type that allows the inner end 10 of the conductive fibrous body 8 in the radial direction R to slide over the inner ring 12.

The present invention is not limited to such a configuration. The bearing seal may be a sliding-over-outer-ring type that allows the outer end 9 of the conductive fibrous body 8 in the radial direction R to slide over the outer ring 11. In a case where the bearing seal 1 shown in FIGS. 1 to 11 is the sliding-over-outer-ring type, the inner-diameter-side lip of the elastic body 5 is engaged in the engagement groove of the inner ring 12 and the outer-diameter-side lip of the elastic body 5 is the non-contact lip that is not in contact with the outer ring 11, or the contact lip that is in contact with the outer ring 11. In a case where the bearing seal 1 shown in FIG. 12 is the sliding-over-outer-ring type, the inner end of seal plate E that is located inward RI in the radial direction R is engaged in the engagement groove of the inner ring 12.

### Effects

According to the bearing seal 1 of the sliding-over-inner-ring type or the bearing seal 1 of the sliding-over-outer-ring type in the embodiment of the present invention shown in FIGS. 1 to 11, the conductive material 3 in contact with the outer ring 11 and the inner ring 12 of the rolling bearing A to electrically connect the outer ring 11 and the inner ring 12 is the conductive fibrous body 8 that is a bundle of conductive fibers and is retained by the seal ring 2 while buried in the elastic body 5 of the seal ring 2 or joined to the elastic body 5 of the seal ring 2. The outer end 9 of the conductive fibrous body 8 in the radial direction R protrudes outward RO in the radial direction R from the seal ring 2, and comes into contact with the outer ring 11 at the position located outward BO in the width direction B of the rolling bearing A relative to the core metal 4. An inner end 10 of the conductive fibrous body 8 in the radial direction R protrudes inward RI in the radial direction R from the seal ring 2 and comes into contact with the inner ring 12 at a position that is outward BO of the rolling bearing A in the width direction B relative to the core metal 4.

In other words, not the elastic body but the conductive fibrous body 8 independent of the elastic body comes in contact with the outer ring 11 and the inner ring 12. The inner end 10 of the conductive fibrous body 8 in the radial direction R slides over the inner ring 12, or the outer end 9 of the conductive fibrous body 8 in the radial direction R slides over the outer ring 11. In this manner, the conductive fibrous body 8, which is a bundle of conductive fibers, is in direct contact with the outer ring 11 and the inner ring 12 of the rolling bearing A to electrically connect the outer ring 11 and the inner ring 12, thereby reducing conductive resistance and achieving excellent conductive stability in comparison with a conductive rubber constructed by mixing a filler (conductive material) into a rubber.

In addition, compared with the bearing seal of PTL 1 in which the conductive material in the outer-diameter-side lip of the elastic body of the seal ring comes in contact with the outer ring and the conductive material in the inner-diameter-side lip of the elastic body of the seal ring comes in contact with the inner ring, the conductive fibrous body 8, i.e., the conductive material 3 is allowed to come into certainly contact with the outer ring 11 and the inner ring 12. This significantly improves conductive stability and facilitates manufacturing of the bearing seal. Furthermore, even if the bearing seal is a type of seal whose lip is in slidably contact with the inner ring, as shown in FIGS. 7 to 10, its conductive material 3 is not exposed from the lip but is independent of the lip, and therefore the conductive material 3 does not affect sealing performance.

According to the bearing seal 1 of the sliding-over-inner-ring type or the bearing seal 1 of the sliding-over-outer-ring type in the embodiment of the present invention as shown in FIG. 12, in a state where the outer end of the annularly-shaped metal seal plate E, which is located outward RO in the radial direction R, is engaged in the engagement groove 11A of the outer ring 11 or the inner end of the annularly-shaped metal seal plate E, which is located inward RI in the radial direction R, is engaged in the engagement groove of the inner ring 12, the inner end 10 in the radial direction R of the conductive fibrous body 8 that is a bundle of conductive fibers and is joined to the seal plate E is in contact with the inner ring 12 at a position that is outward BO in the width direction B of the rolling bearing A relative to the seal plate E and the outer end 9 of the conductive fibrous body 8 in the radial direction R is in contact with the outer ring 11 at a position that is outward BO in the width direction B of the rolling bearing A relative to the seal plate E.

In other words, not the elastic body but the conductive fibrous body 8 is in contact with the outer ring 11 and the inner ring 12. Thus, the conductive fibrous body 8, which is a bundle of conductive fibers, is in direct contact with the outer ring 11 and the inner ring 12 of the rolling bearing A to electrically connect the outer ring 11 and the inner ring 12. Therefore, conductive resistance is reduced and conductive stability is improved, in comparison with a conductive rubber constructed by mixing a filler (conductive material) into a rubber.

In addition, in comparison with the bearing seal of PTL 1 in which the conductive material in the outer-diameter-side lip of the elastic body of the seal ring comes in contact with the outer ring and the conductive material in the inner-diameter-side lip of the elastic body of the seal ring comes in contact with the inner ring, conductive stability is significantly improved and manufacturing of the bearing seal is facilitated.

The above description of the embodiments is entirely exemplary, and therefore the present invention is not limited by this description. The present invention may be modified or revised in various forms within the scope of the present invention.

### REFERENCE SIGNS LIST

1 bearing seal
2 seal ring
3 conductive material
4 core metal
5 elastic body
6 outer-diameter-side lip
7 inner-diameter-side lip
8 conductive fibrous body
9 outer end in the radial direction
10 inner end in the radial direction
11 outer ring
11A engagement groove
12 inner ring
12A seal groove
13 rolling element
14 retainer
A rolling bearing
B width direction
BI inward
BO outward
C circumferential direction
D center in the width direction
E metal seal plate
O rotation center axis
R radial direction
RI inward
RO outward

1. A bearing seal used for a rolling bearing including an outer ring, an inner ring, and rolling elements, the bearing seal comprising:
an annularly-shaped seal ring including a core metal and an elastic body; and
a conductive material in contact with the outer ring and the inner ring to electrically connect the outer ring and the inner ring, wherein
the elastic body has an outer-diameter-side lip extending radially outward and an inner-diameter-side lip extending radially inward,
the conductive material is a conductive fibrous body that is a bundle of conductive fibers, and is retained by the seal ring in a state where the conductive fibrous body is buried in the elastic body or is joined to the elastic body,
the conductive fibrous body independent of the outer-diameter-side lip and the inner-diameter-side lip includes:
a radially outer end coming in contact with the outer ring at a position that is outward in a width direction in the rolling bearing relative to the core metal; and
a radially inner end coming in contact with the inner ring at a position that is outward in the width direction in the rolling bearing relative to the core metal.

2. (canceled)

3. A bearing seal used for a rolling bearing including an outer ring, an inner ring, and rolling elements, the bearing seal comprising:
an annularly-shaped metal seal plate; and
a conductive material joined to the seal plate, wherein
the conductive material is a conductive fibrous body that is a bundle of conductive fibers, and
the conductive fibrous body includes:
a radially inner end coming in contact with the inner ring at a position that is outward in a width direction of the rolling bearing relative to the seal plate; and
a radially outer end coming in contact with the outer ring at a position that is outward in the width direction of the rolling bearing relative to the seal plate.

4. (canceled)

5. The bearing seal according to claim 1, wherein
the conductive fibrous body extends linearly in a radial direction.

6. The bearing seal according to claim 3, wherein the conductive fibrous body extends linearly in a radial direction.
